(19) United States
(12) Patent Application Publication
(10) Pub. No.: US 2005/0113036 A1
(43) Pub. Date: May 26, 2005

(54) Cellular telephone and linking mechanism

(76) Inventor: Edward Lita, Las Vegas, NV (US)

Correspondence Address: JEFFER, MANGELS, BUTLER & MARMARO, LLP, 1900 AVENUE OF THE STARS, 7TH FLOOR, LOS ANGELES, CA, 90067, US

(21) Appl. No.: 10/719,095

(22) Filed: Nov. 20, 2003

(51) Int. Cl. H04Q 7/20

(52) U.S. Cl. 455/90.3

(57) ABSTRACT

A cellular telephone and method of carrying a cellular telephone are disclosed. The cellular telephone has an antenna with a loop spaced apart from the cellular telephone housing. The loop is preferably attached to a key chain ring for further attachment to items such as belt loops, purse straps, luggage handles, bands, and chains, thereby providing improved ease of handling and carrying of the cellular telephone.

### FIELD OF THE INVENTION

The present invention relates to cellular phones and more particularly to cellular phone antennas suitable for attachment to key chain rings, belt loops, straps, handles, hooks and other structures for ease in handling and carrying the phone.

### BACKGROUND OF THE INVENTION

Because of their portability, cellular telephones have provided users with the ability to communicate by phone from a variety of locations and while performing a variety of activities, such as driving, walking, sitting in a restaurant, etc. The recent trend in cellular telephone design has been to reduce the overall size and weight of the phone, thereby increasing portability. A cellular telephone includes a housing, typically 3 inches long and 2 to 3 inches wide, and an antenna, typically 2 to 3 inches in length.

Because of the trend towards size reduction, it has become increasingly difficult to securely carry and handle newer cellular phones, increasing the likelihood that users will inadvertently damage or misplace them. For example, merely placing the newer phones in a pants or shirt pocket may result in the phone falling out and becoming damaged or lost.

As a result, a need now exists for a cellular phone that solves the foregoing problems.

### SUMMARY OF THE PREFERRED EMBODIMENTS

In accordance with one aspect of the present invention, there is provided a cellular telephone having an antenna which has a loop spaced apart from the cellular telephone housing.

In preferred embodiments, the cellular telephone includes a second loop which links to the antenna loop.

In additional preferred embodiments, the antenna loop is closed.

In additional preferred embodiments, the second loop is a ring.

In additional preferred embodiments, the ring is a key chain ring.

In additional preferred embodiments, the cellular telephone antenna consists of wire.

In additional preferred embodiments, the antenna is at least partially exposed.

In accordance with another aspect of the present invention, there is provided a cellular telephone having an antenna with an aperture. In additional preferred embodiments, the cellular telephone includes a loop linked through the aperture of the antenna.

In accordance with another aspect of the present invention, there is provided a cellular telephone having a housing with an aperture. In additional preferred embodiments, the cellular telephone includes a loop linked through the aperture of the housing.

In accordance with another aspect of the present invention, there is provided a method of carrying a cellular telephone. A cellular telephone is provided which has an antenna with a loop spaced apart from the cellular telephone housing. A key chain ring is linked to the loop of the antenna. The key chain ring is also linked to a device. In additional preferred embodiments, the device is a belt, strap, hook, band or chain. In additional preferred embodiments, an antenna is provided which includes an aperture to which a key chain ring is linked.

In accordance with another aspect of the present invention, there is provided a method of carrying a cellular telephone which includes providing a cellular telephone having an antenna formed into a shape capable of linking to a loop. A loop is linked to the antenna. The loop is then linked to a belt, belt loop, strap, handle, hook, band, key chain clip, line or chain. In a preferred embodiment, the loop is a key chain ring.

In accordance with yet another aspect of the present invention, a cellular telephone handling and security system is provided. The system includes an antenna having first and second ends. The second end is associated with another portion of the antenna. Preferably, a loop is then linked to the antenna. In a preferred embodiment, the loop is a ring. In additional preferred embodiments, the ring is a key chain ring. In additional preferred embodiments, the second end of the antenna is no more than 1.0 mm from the other portion of the antenna with which it is associated. In additional preferred embodiments, the system includes an antenna with an aperture through which a loop is linked.

Other objects, features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which:

FIG. 1 is a front elevational view of a cellular telephone in accordance with a first preferred embodiment of the present invention;

FIG. 2 is a front elevational of a cellular telephone in accordance with another preferred embodiment of the present invention in which the cellular telephone antenna is linked to a loop;

FIG. 3 is a front elevational view of a cellular telephone with a square-shaped antenna loop, in accordance with another preferred embodiment of the present invention;

FIG. 4 is a front elevational view of a cellular telephone in accordance with another preferred embodiment of the present invention;

FIG. 5 is a front elevational view of a cellular telephone and antenna attached to a belt loop in accordance with another preferred embodiment of the present invention;

FIG. 6 is a front elevational view of a handling and security system in accordance with a preferred embodiment of the present invention; and

FIG. 7 is a front elevational view of a cellular telephone in accordance with another preferred embodiment of the present invention.

FIG. 8 is a front elevational view of a cellular telephone in accordance with another preferred embodiment of the present invention.

Like numerals refer to like parts throughout the several drawings.

### DETAILED DESCRIPTION OF THE PREFERRED EMBODIMENTS

As used herein, the term “loop” means “a fold or doubling of a line leaving an aperture between the parts through which another line can be passed or into which a hook may be hooked.” As used herein, the phrase “at least partially exposed” when used in reference to an antenna, means that a part or all of the antenna is visible to the cellular telephone user.

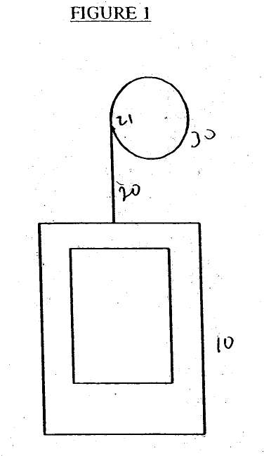

Referring to FIG. 1, a cellular phone is depicted in accordance with a first preferred embodiment of the present invention. A cellular telephone housing 10, encloses a transceiver (not shown). An antenna 20 is electrically coupled to the transceiver and extends from housing 10. The antenna 20 may be fixed with respect to the housing 10, or alternatively, some part or all of the antenna may be retractable into and extendable from the housing 10. Furthermore, the antenna 20 may be separately detachable from the transceiver.

The antenna 20 may be constructed from a variety of conventional materials that are known in the art. In a preferred embodiment, the antenna consists of wire. In another preferred embodiment, a wire antenna 20 can be covered with another material such as rubber or plastic, but at least a portion of the wire is exposed.

In the embodiment of FIG. 1, the antenna 20 includes a loop 30 spaced apart from the housing 10. It is preferred to form the loop 30 by manually bending and/or twisting the antenna. Alternatively, the loop may comprise a separate piece of wire or other suitable material attached to a straight portion of an antenna. In the embodiment of FIG. 1, a closed, circular loop is provided. Such a loop can be formed by known techniques, for example, by manually bending antenna 20 and soldering distal end 21 to another point on antenna 20. Instead of soldering, mechanical engagement techniques can also be used such as shaping the end of the antenna to hook onto another portion of the antenna after bending. Other techniques such as molding, pressing, drilling or grinding can also be used to form the loop 30.

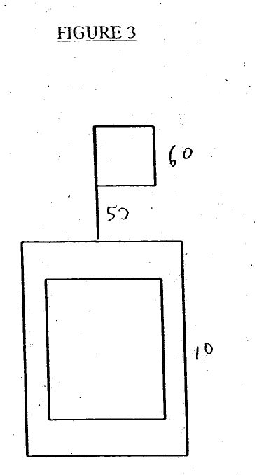

Although a circular loop shape is depicted in FIG. 1, various loop shapes are possible without departing from the scope of the present invention. For example, in another preferred embodiment depicted in FIG. 3, an antenna 50 includes a square loop 60 spaced away from housing 10. Alternatively, non-geometric or irregular loop shapes, such as those that are not circular, oval, or polygonal in nature, can be used.

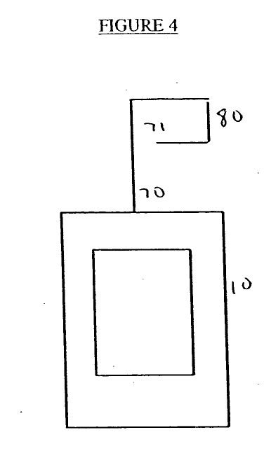

In yet another preferred embodiment, depicted in FIG. 4, antenna 70 includes a loop 80 that is not closed. In this embodiment, the antenna 70 is bent such that the distal end 71 is associated with another point on antenna 70. Preferably the distal end 71 is no more than 1.5 mm and even more preferably no more than 1.0 mm from the point on antenna 70 with which it is associated.

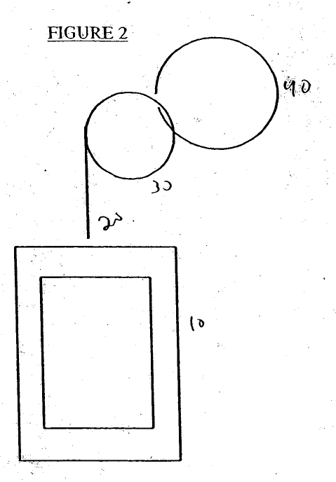

In another preferred embodiment, depicted in FIG. 2, a second loop 40 is linked to the first loop 30 of the antenna. In a preferred embodiment, the second loop is a conventional key chain ring, capable of being removably attached to the loop 30, thereby allowing users to keep their cellular telephone on a ring with their house keys, car keys, etc. As with the loop 30, the second loop 40 can take a variety shapes and is not limited to the circular shape shown in the figure.

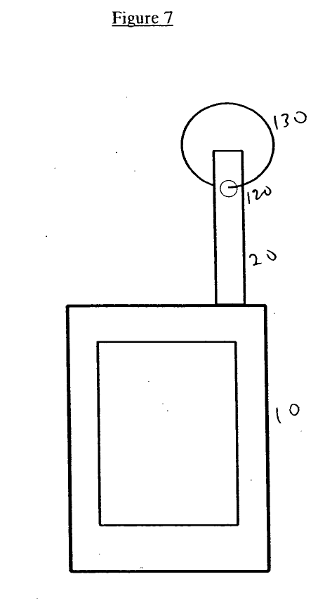

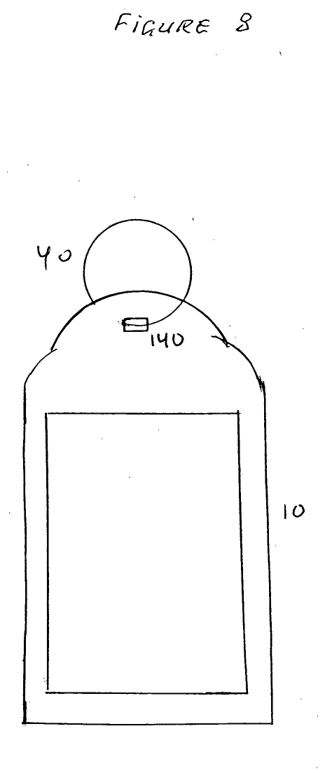

In still another preferred embodiment, depicted in FIG. 7, antenna 20 has an aperture 120. Such an aperture can be formed by known techniques such as drilling, or burning. The antenna 20 and aperture 120 can also be formed by molding, pressing or grinding. In a preferred embodiment, the antenna 20 has a ½ diameter or width and the aperture 120 is 1/16 in. to ½ in. in size. In a preferred embodiment, loop 130 is linked to antenna 20 through aperture 120. Preferably, loop 130 is a key chain ring. The aperture can be a variety of shapes, including geometric shapes, as well as non-geometric or irregular shapes. Alternatively, as depicted in FIG. 8, the cellular telephone housing 10 can include an aperture 140 through which loop 40 can then be linked.

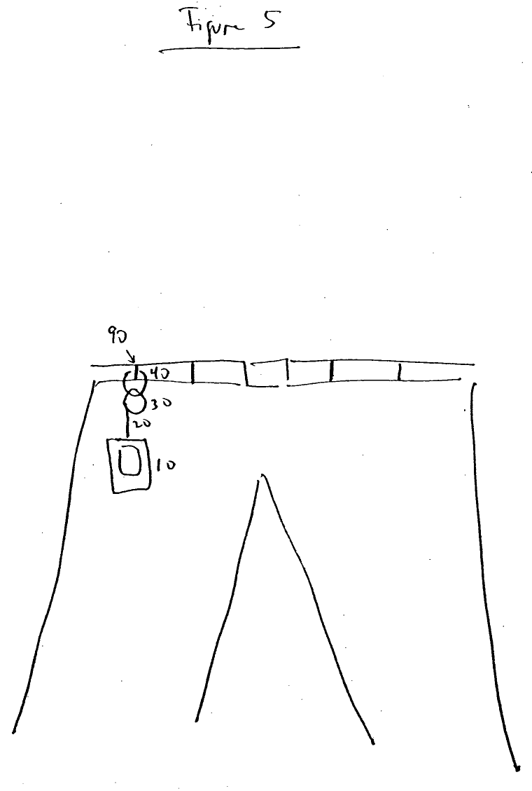

In yet another preferred embodiment, depicted in FIG. 5, a method of carrying a cellular telephone is shown. In this embodiment, a cellular telephone housing 10 and antenna 20 are provided. As with the embodiment depicted in FIG. 1, antenna 20 includes a loop 30 spaced apart from the housing. According to this embodiment, the user links loop 30 to a second loop 40, which is preferably a key chain ring or other removably attachable ring. Second loop 40 is then linked to a belt loop 90 for ease of handling and carrying. Although a belt loop 90 is depicted in FIG. 5, a number of other items such as belts, purse straps, luggage handles, bands, key chain clips, lines, and chains are also suitable for linking to the second loop 40 and are within the scope of the present invention.

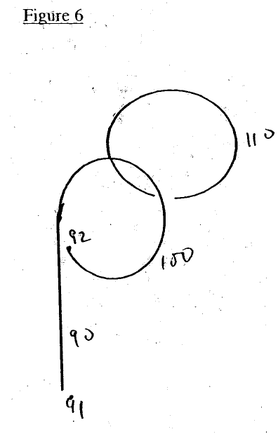

Although the present invention has been described in the context of a cellular telephone system, it can be used with a variety of other electronic components, such as cordless phones or handheld radios. In another preferred embodiment of the present invention, a handling and security system is provided, as depicted in FIG. 6. The handling and security system includes an antenna 90 having a first end 91 and a second end 92. The second 92 is associated with the another portion of the antenna by conventional means, such as manually bending the antenna. Another loop 110 is linked to antenna 90. Preferably, loop 110 is a key chain ring or other removably attachable ring. The user can attach antenna 90 to a cellular phone or other electronic component and optionally detach it when desired. After attaching antenna 90 to an electronic component, the user can then link loop 110 to a desired item such as a belt, belt loop, purse strap, luggage handle, etc. In another preferred embodiment, the handling and security system includes an antenna with an aperture and a loop linked through the aperture.

The foregoing embodiments are merely exemplary embodiments of the present invention. Those skilled in the art may make numerous uses of, and departures from, such embodiments without departing from the spirit and the scope of the present invention. Accordingly, the scope of the present invention is not to be limited or defined by such embodiments in any way, but rather, is defined solely by the following claims.

1. A cellular telephone, comprising:
a. A housing;
b. a transceiver enclosed in said housing; and
c. an antenna electrically coupled to said transceiver and having a first loop spaced apart from said housing.

2. The cellular telephone of claim 1, wherein said first loop is closed.

3. The cellular telephone of claim 1, further comprising a second loop linked to said first loop.

4. The cellular telephone of claim 1, wherein said antenna consists of wire.

5. The cellular telephone of claim 1, wherein said antenna is at least partially exposed.

6. The cellular telephone of claim 3, wherein said second loop is a ring.

7. The cellular telephone of claim 6, wherein said ring is a key chain ring.

8. The cellular telephone of claim 1, wherein said first loop is removably attached to said antenna.

9. A cellular telephone, comprising:
a. a housing;
b. a transceiver enclosed in said housing;
c. a wire antenna electrically coupled to said transceiver and having a closed loop spaced apart from said housing, wherein said wire antenna is at least partially exposed; and
d. a key chain ring linked to said loop.

10. The cellular telephone of claim 9, wherein said loop is removably attached to said antenna.

11. A method of carrying a cellular telephone, comprising:
a. providing a cellular telephone having a transceiver;
b. providing an antenna electrically coupled to said transceiver, wherein said antenna has a loop spaced apart from said housing;
c. linking a key chain ring to said loop; and
d. linking a device to said key chain ring.

12. The method of claim 11, wherein the device is selected from a group consisting of a belt, belt loop, strap, handle, hook, band, key chain clip, line and chain.

13. The method of claim 11, wherein said antenna consists of wire.

14. The method of claim 11, wherein said antenna is at least partially exposed.

15. The method of claim 11, wherein said loop is closed.

16. A method of carrying a cellular telephone, comprising:
a. providing a cellular telephone having a housing;
b. providing a wire antenna electrically coupled to said transceiver, wherein said antenna is at least partially exposed and has a closed loop spaced apart from said housing;
c. linking a key chain ring to said loop; and
d. linking a device to said key chain ring, wherein said device is selected from a group consisting of a belt, belt loop, strap, handle, hook, band, key chain clip, line, and chain.

17. A handling and security system, comprising:
a. an antenna having a first end and second end, wherein said second end is associated with another portion of said antenna; and
b. a loop linked to said antenna.

18. The handling and security system of claim 17, wherein said loop is a ring.

19. The handling and security system of claim 18, wherein said ring is a key chain ring.

20. The handling and security system of claim 17, wherein said antenna consists of wire.

21. The handling and security system of claim 17, wherein said antenna is at least partially exposed.

22. The handling and security system of claim 17, wherein said second end is not more than 1.0 mm from said another portion of said antenna.

23. A method of carrying a cellular telephone, the method comprising:
a. providing a cellular telephone having an antenna formed into a shape capable of linking to a loop;
b. linking a loop to said antenna;
c. linking said loop to a device selected from the group consisting of a belt, belt loop, strap, handle, hook, band, key chain clip, line, and chain.

24. The method of claim 23, wherein said loop is a ring.

25. The method of claim 24, wherein said ring is a key chain ring.

26. The method of claim 23, wherein said antenna is at least partially exposed.

27. The method of claim 23, wherein said antenna consists of wire.

28. A cellular telephone, comprising:
a. A housing;
b. A transceiver enclosed in said housing; and
c. an antenna electrically coupled to said transceiver and having a first and second end, wherein said second end is associated with another portion of said antenna.

29. The cellular telephone of claim 28, further comprising a loop linked to said antenna.

30. The cellular telephone of claim 28, wherein said antenna consists of wire.

31. The cellular telephone of claim 28, wherein said antenna is at least partially exposed.

32. The cellular telephone of claim 28, wherein said second end is not more than 1.0 mm from said another portion of said antenna.

33. The cellular telephone of claim 29, wherein said loop is a ring.

34. The cellular telephone of claim 33, wherein said ring is a key chain ring.

35. A method of carrying a cellular telephone, comprising:
a. providing a cellular telephone having a transceiver;
b. providing an antenna electrically coupled to said transceiver, wherein said antenna has a first and second end and wherein said second end is associated with another portion of said antenna;
c. linking a key chain ring to said antenna; and
d. linking a device to said key chain ring.

36. The method of claim 35, wherein the device is selected from a group consisting of a belt, belt loop, strap, handle, hook, band, key chain clip, line and chain.

37. The method of claim 35, wherein said antenna consists of wire.

38. The method of claim 35, wherein said antenna is at least partially exposed.

39. The method of claim 35, wherein said second end of said antenna is no more than 1.0 mm from said another portion of said antenna.

40. A cellular telephone, comprising:
a. a housing;
b. a transceiver enclosed in said housing; and
c. an antenna electrically coupled to said transceiver and having an aperture.

41. The cellular telephone of claim 40, further comprising a loop linked to said antenna through said aperture.

42. The cellular telephone of claim 41, wherein said loop is a ring.

43. The cellular telephone of claim 42, wherein said ring is a key chain ring.

44. The cellular telephone of claim 40, wherein the size of said aperture is between 1/16 in. and ½ in.

45. A cellular telephone, comprising:
a. a housing;
b. a transceiver enclosed in said housing;
c. an antenna electrically coupled to said transceiver and having an aperture of a size between 1/16 in. and ½ in.; and
d. a key chain ring, linked to said antenna through said aperture.

46. A method of carrying a cellular telephone, comprising:
a. providing a cellular telephone having a transceiver;
b. providing an antenna electrically coupled to said transceiver and having an aperture;
c. linking a key chain ring through said aperture of said antenna; and
d. linking a device to said key chain ring.

47. The method of claim 46, wherein the size of said aperture is between 1/16 in. and ½ in.

48. The method of claim 46, wherein the device is selected from a group consisting of a belt, belt loop, strap, handle, hook, band, key chain clip, line and chain.

49. A method of carrying a cellular telephone, comprising:
a. providing a cellular telephone having a transceiver;
b. providing an antenna electrically coupled to said transceiver and having an aperture of a size between 1/16 in. and ½ in.;
c. linking a key chain ring through said aperture of said antenna; and
d. linking a device to said key chain ring, wherein said device is selected from a group consisting of a belt, belt loop, strap, handle, hook, band, key chain clip, line, and chain.

50. A handling and security system, comprising:
a. an antenna having an aperture; and
b. a loop linked through said aperture of said antenna.

51. The handling and security system of claim 50, wherein the loop is a ring.

52. The handling and security system of claim 51, wherein said ring is a key chain ring.

53. The handling and security system of claim 50, wherein the size of said aperture is between 1/16 in. and ½ in.

54. A cellular telephone, comprising:
a. a housing having an aperture; and
b. a transceiver enclosed in said housing.

55. The cellular telephone of claim 54, further comprising a loop linked to said housing through said aperture.

56. The cellular telephone of claim 55, wherein said loop is a ring.

57. The cellular telephone of claim 56, wherein said ring is a key chain ring.

58. The cellular telephone of claim 54, wherein the size of said aperture is between 1/16 in. and ½ in.

59. A cellular telephone, comprising:
a. a housing having an aperture;
b. a transceiver enclosed in said housing; and
c. a key chain ring, linked to said housing through said aperture.

60. A method of carrying a cellular telephone, comprising:
a. providing a cellular telephone having a transceiver and a housing, wherein said housing has an aperture;
b. linking a key chain ring through said aperture of said housing; and
c. linking a device to said key chain ring.

61. The method of claim 60, wherein the size of said aperture is between 1/16 in. and ½ in.

62. The method of claim 60, wherein the device is selected from a group consisting of a belt, belt loop, strap, handle, hook, band, key chain clip, line and chain.

63. A method of carrying a cellular telephone, comprising:
a. providing a cellular telephone having a transceiver and a housing, wherein said housing has an aperture;
b. linking a key chain ring through said aperture of said antenna; and
c. linking a device to said key chain ring, wherein said device is selected from a group consisting of a belt, belt loop, strap, handle, hook, band, key chain clip, line, and chain.
